(19) United States
(12) Patent Application Publication
(10) Pub. No.: US 2008/0226534 A1
(43) Pub. Date: Sep. 18, 2008

(54) Adsorbent Articles for Disk Drives

(76) Inventors: Rajan H. Gidumal, Newark, DE (US); Xiao-Chun Lu, Newark, DE (US); Glenn S. Shealy, Hockessin, DE (US)

Correspondence Address: GORE ENTERPRISE HOLDINGS, INC., 551 PAPER MILL ROAD, P. O. BOX 9206, NEWARK, DE, 19714-9206, US

(21) Appl. No.: 11/685,333

(22) Filed: Mar. 13, 2007

(51) Int. Cl. C01B 31/00; C01G 1/04

(52) U.S. Cl. 423/416; 423/414; 423/415.1

(57) ABSTRACT

An improved activated carbon adsorbent for disk drives that has improved or increased adsorption capacity for moisture between 25% RH and 45% RH while optionally maintaining good capacity for organic vapors, acid gasses and moisture at 95% RH.

### FIELD OF THE INVENTION

This invention relates to devices for filtering, adsorbing, or removing contaminants from a disk drive.

### BACKGROUND OF THE INVENTION

Many enclosures that contain sensitive instrumentation or equipment must maintain very clean environments in order to operate properly. Examples include: enclosures with sensitive optical surfaces or electronic connections that are sensitive to particulates and gaseous contaminants which can interfere with mechanical or electrical operation; data recording devices, such as computer hard disk drives that are sensitive to particles, organic vapors, moisture, and corrosive vapors; and electronic control boxes such as those used in automobiles that are sensitive to moisture buildup and corrosion as well as contamination from fluids and vapors. Contamination in such enclosures (hereinafter collectively referred to as “Disk Drives”) originates from both inside and outside the enclosures. For example, in computer hard drives, damage may result from external contaminates as well as out-gassing and particle generation from internal components.

Disk Drives are sensitive to humidity variations. Low humidity is problematic because it may increase static electricity or decrease lubricant effectiveness, thickness or functionality. However, high humidity may promote corrosion and lubricant swelling. Disk media have progressively thinner and thinner protective layers increasing the risk of corrosion. Perpendicular recording media have thin layers of metal susceptible to corrosion at even moderate humidity.

It takes significantly more adsorbent volume to protect a drive from humidity than it does from organic or acid gas contamination because the moisture concentrations are significantly higher than organic or other gas concentrations. As a result drives that need buffering from humidity fluctuations require significant amounts of adsorbent. Adsorbents that perform in the proper relative humidity ranges of interest are critical.

In addition to moisture protection, disk drives must be protected against a large number of other contaminants in the surrounding environment. This is true for drives used in small to medium sized computer systems which may not be used in the typical data processing environment and is especially true in drives that are removable and transportable. Examples of such applications include disk drives that are used in Personal Computer Memory Card International Association (PCMCIA) Slots, music devices, car navigational applications, and in cell phones. Each new consumer application brings its own set of conditions within which the Disk Drive needs to be able to operate.

Several performance requirements for adsorbents often conflict. One requirement is to adsorb relatively high capacities of low concentration organic vapors. Another requirement is to maintain a high capacity for moisture within the drives to prevent condensation. A third need is to control or buffer the relative humidity inside the drive. A fourth requirement is to control acid gases inside the drive to minimize corrosion.

Organic vapors must be kept to very low levels. Contaminate concentration inside the drives are often in the 1 ppb level or lower. The adsorbent must adsorb the contaminant before it condenses onto the head or disk where it can cause a problem for the drives. Adsorbents with a high surface area and a large percentage of micropores are typically best for these applications.

Moisture control is particularly important in moderate to high levels of relative humidity. Drives must not be too dry because some moisture is often desired for optimal lubrication effects inside the drive. When operated in high RH conditions, condensation can seriously corrode and damage a drive. An adsorbent with high capacity at 95% RH and an upward sloping isotherm between 85% RH and 95% RH is particularly preferred. Typically adsorbents with a high pore volume are best for high end moisture capacity, but such adsorbents have lower surface area and a smaller percentage of micropores. These adsorbent are thus less effective at moisture capacity at low to moderate RH.

Head and disk components may start to corrode at humidity above 45% RH. Thus for good protection during drive storage and shipping, a large moisture capacity between 25% RH and 45% RH is desired. Additionally, significant moisture capacity allows the adsorbent to buffer the drive during on/off cycles while operating at different extremes of RH. For adsorption in the middle RH ranges, an adsorbent that does not adsorb moisture too readily at low RH range, but that does adsorb moisture in the mid RH range is needed. These requirements are typically not met by activated carbons known for use in Disk Drives.

Silica gel is used within some Disk Drives to help adsorb and buffer humidity, but there are also problems with silica adsorbents. First, while silica gel has significant moisture adsorption capacity below 25% RH, and moderate capacity between 25% RH and 45% RH, at RH above 45% silica has very little capacity. It has very little buffering to prevent the condensation conditions when disk drives are moved from hot environments into cold environments. Moreover, silica gel is a very hard material that can do substantial damage if it contacts the head or disk.

Increasing overall adsorbent performance allows less adsorbent to be used in disk drives to obtain the needed adsorbent capacities. Reducing adsorbent volume is extremely important in hard disk drives where space is extremely limited.

Accordingly, there is a need for improved adsorbent filters that overcome the foregoing limitations and improve the control of moisture in conditions of moderate RH (25%-45% RH) while maintaining good organic, acid gas, and high end RH control.

### SUMMARY

In one aspect, an adsorbent article for a disk drive comprising carbon adsorbent having functional end groups is provided. The functional end groups comprise oxygen such that the carbon adsorbent comprises at least about 13.5 percent oxygen by weight. Preferably, the carbon adsorbent comprises at least 15.0 percent oxygen by weight. The functional end groups may comprise carboxyls, carbonyls, carboxylic acids, phenols, quinones, ethers, anhydrides and lactones. Preferably, the functional end groups are covalently bonded to the carbon adsorbent such that the end groups impart new chemical functionality to the carbon adsorbent. The adsorbent article may be in the form of a tablet, filled tape adsorbent embedded fabric, adsorbent beads or adsorbent granules.

In another aspect, an adsorbent article for a disk drive comprises carbon adsorbent having functional end groups comprising about 6.0 percent nitrogen, sulfur, phosphorous, bromine, chlorine, or fluorine. Preferably, the functional end groups comprise amines, phosphates, sulfates, chlorides, or fluorides.

In still another aspect, an adsorbent article for a disk drive comprises carbon adsorbent having more than about 40 meq/100 grams of total acidity as determined by Boehm titration. Preferably, the carbon adsorbent has more than 50 meq/100 grams of total acidity as determined by Boehm titration, more preferably the carbon adsorbent has more than 70 meq/100 grams of total acidity as determined by Boehm titration, most preferably carbon adsorbent has more than 90 meq/100 grams of total acidity as determined by Boehm titration.

In yet another aspect, an adsorbent device for a disk drive comprises a carbon adsorbent adapted to have a moisture capacity at moderate RH of greater than 14%. Preferably, the carbon adsorbent is adapted to have a moisture capacity at moderate RH of greater than 17%. More preferably, the carbon adsorbent is adapted to have a moisture capacity at moderate RH of greater than 20%.

In a further aspect, an adsorbent device for a disc drive is provided in which the adsorbent comprises carbon adsorbent adapted to absorb moisture such that the adsorbent device adsorbs at least 0.08 g water per cubic centimeter of adsorbent device volume at moderate RH. Preferably, the adsorbent device adsorbs at least 0.10 g water per cubic centimeter of adsorbent device volume at moderate RH.

In yet another aspect, an adsorbent for a disk drive comprises carbon adsorbent adapted such that the carbon adsorbent has a moisture capacity of greater than 14% at moderate RH and a TMP capacity of greater than about 17.5 percent by weight.

### BRIEF DESCRIPTION OF THE DRAWINGS

The operation and use of the present invention should become apparent from the following description when considered in conjunction with the accompanying drawings, in which:

FIG. 1 is a cross-sectional view of a first embodiment of the filter unit utilizing functionalized adsorbent in tape or tablet form in an Adsorbent Assembly.

FIG. 2 is a cross-section view of a second embodiment utilizing functionalized adsorbent in a tape or tablet form in an Adsorbent Breather Filter.

FIG. 3A is a cross-sectional view of a third embodiment utilizing functionalized adsorbent in a tape, tablet, or particulate form in an Adsorbent Box.

FIG. 3B is a cross-sectional view of a third embodiment showing functionalized adsorbent in a tape, tablet, or particulate form in an adsorbent breather box.

FIGS. 4A and 4B are top and cross-sectional views respectively of a fourth embodiment functionalized adsorbent in a tape, tablet or particulate form in an adsorbent recirculation filter.

FIG. 5 shows a cross sectional sketch of a hard disk drive where one embodiment of the present invention may be located.

FIG. 6 shows a schematic for the Gravimetric Water Vapor Adsorption/Desorption Analyzer used in testing examples.

FIG. 7 shows a schematic for the Gravimetric Organic Vapor adsorption Measurement System used in testing examples.

### DETAILED DESCRIPTION

The present invention provides a Disk Drive filter with an adsorbent to improve performance in conditions of 25% to 45% relative humidity. As used herein 25% to 45% Relative Humidity is referred to as “moderate RH”. The adsorbents described perform well in moderate RH without sacrificing adsorption performance above 85% RH and organic and acid gas protection.

Most activated carbon adsorbents have low capacity for moisture below 45% RH. In other words, the surface of the activated carbon in these ranges is hydrophobic. This hydrophobicity reduces activated carbon's moisture adsorbing capacity below 45% RH. By providing activated carbon with a more hydrophilic surface, moisture adsorption at moderate RH is improved. Hydrophilic surfaces may be obtained by treating an activated carbon to create functional end groups. It is also possible to make hydrophilic activated carbons by choosing the proper precursor material and treatment, carbonization, and activation processes.

To make an activated carbon surface more hydrophilic, functional end groups may be added to the activated carbon surface. Adding atoms such as oxygen, nitrogen, bromine, chlorine, fluorine and phosphorus or other polar molecules to the surface chemistry can change the affinity for moisture of the carbon surface. These atoms can be fixed to the carbon matrix in the form of groups analogous to organic species such as carboxyls, carbonyls, phenols, ketones, amines, phosphates, carboxylic, quinones, anhydrides, esters, lactones and other such compounds. These groups can be added to activated carbons by treating the carbons with a number of compounds.

For example, carbon may be treated by soaking in chemical solutions containing, for example ammonia persulfate. Alternatively, carbon may be treated with other chemicals such as peroxide. Treatment with other chemicals such as ozone, sodium persulfate, or nitric acid will also add functional groups to carbon. Such treatments break some of the carbon-carbon bonds and substitute functional groups covalently bonded to the carbon surface.

After treatment to provide functional end groups to the carbon surface, the carbon adsorbent may be salt treated to improve acid gas adsorption capacity. The resulting carbon is a functionalized carbon adsorbent having good moisture capacity over the entire RH spectrum, but demonstrates uniquely high capacity at moderate RH range. Moreover, low concentration organic capacity and acid gas capacity are not compromised.

Functional end groups on activated carbon surface can be measured in several ways, including elemental analysis, Boehm titration, inverse gas chromatography and temperature programmed desorption (“TPD”). These exemplary methods of determining the presence and quantity of functional end groups are in no way limiting. However the analysis is performed, the activated carbon should be washed with deionized water and dried prior to analysis to wash off surface salts and other non-covalently bonded treatments to ensure an accurate carbon weight.

Elemental analysis may be performed by a number of methods, including, for example, pyrolizing the carbon in an inert atmosphere and looking for elemental species other than carbon. The presence and quantity of elemental species indicate functional groups on the activated carbon.

Another method for quantifying functional end groups is by Boehm titration. Boehm titration is generally described by Salame and Bandosz in “Experimental Study of Water Adsorption on Activated Carbon” in LANGMUIR, Volume 15, Issue 2, (1999) pp 587-593.

Still another method for determining quantifying functional end groups on a carbon surface is inverse gas chromatography, as summarily described by Bendosz, Jagiello, and Schwarz in a paper entitled “Comparison Of Methods To Assess Surface Acidic Groups On Activated Carbon” ANALYTICAL CHEMISTRY Volume 64, Number 8, (1992) pages 891-895.

Still another method for quantifying functional groups is TPD. This method is discussed by Figueiredo, Pereira, Freitas, and Órfão in “Modification Of The Surface Chemistry Of Activated Carbons” CARBONS Volume 37 (1999), pages 1379-1389. In TPD, certain functional surface groups such as carboxylic groups, lactone groups, phenol groups, carbonyl groups, anhydride groups, ether groups, and quinine groups are associated with decomposition to CO and CO₂. Release of CO and CO₂ during decomposition indicates the presence of these functional end groups.

The adsorbent can be incorporated into a filter for a Disk Drive in a variety of physical forms. Examples include a filled tape such as a structure taught by U.S. Pat. No. 4,985,296 issued to Mortimer, Jr., an adsorbent loaded material such as a nonwoven, a tablet, or a powdered or particulate form. Filled tape structures or goods in roll form (“Roll Goods”) are advantageously suitable for use in high speed rotary die cutting equipment with high capacity throughout.

The present invention can be incorporated into many different adsorbent filter constructions such as an adsorbent breather filter (with or without an incorporated diffusion tube), an adsorbent assembly, an adsorbent recirculation filter, an adsorbent box, an adsorbent breather box, a Gore-Sorber™ Module, or any other adsorbent-containing filter construction within the Disk Drive. Filters may be mounted inside the drive or mounted to the outside of the drive with access to the inside of the drive through an opening in the drive housing.

Filters utilizing the adsorbent described herein may be made multifunctional by incorporating filter layers that add particle filtration functionality. Multifunctional filters filter both the incoming air through an active breather filter section and air circulating or recirculating around inside the drive.

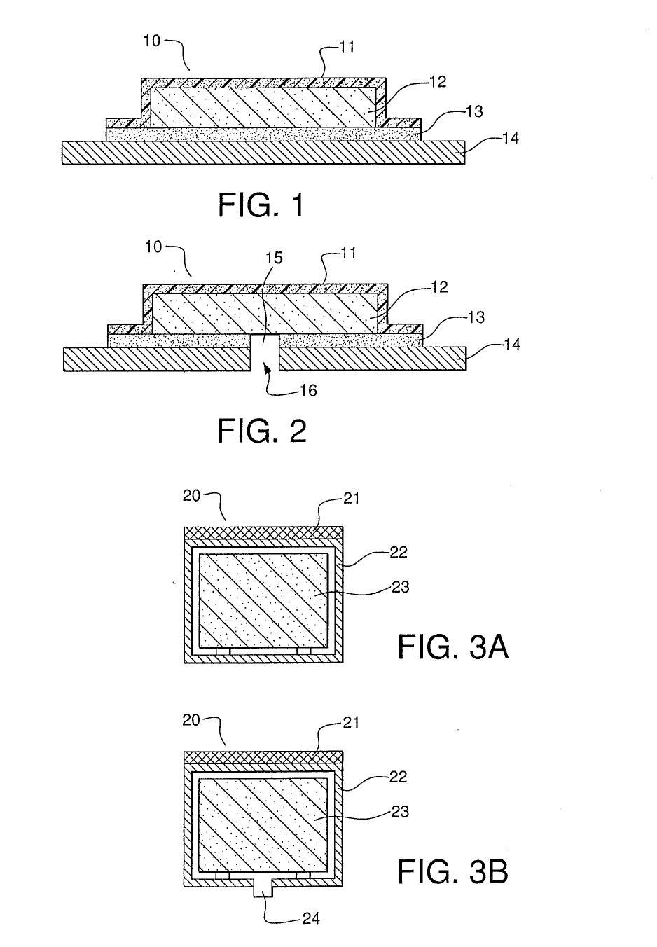

Examples of filters utilizing the adsorbent present invention are not limited to but can be illustrated by FIGS. 1 through 4. FIG. 1 shows a cross-sectional view of a filter. Filter 10 includes an adsorbent material or an adsorbent filled tape forming the sorbent core 12. Layer 13 can be an adhesive which may be a layer of adhesive or a layer of double sided adhesive comprising two layers of adhesive on either side of a carrier. Layer 11 is typically a filter layer used to contain the adsorbent within the filter or within the layers of filter 11 and adhesive 13. The adhesive layer 13 can further be used to adhere or mount the filter to a surface of the drive case 14.

The filter layer 11 may comprise any porous material that allows vapor contaminants to diffuse through to the adsorbent media while thoroughly retaining the adsorbent material within. Appropriate filter materials can be chosen by one of skill in the art, depending upon the adsorbent type and form chosen, Suitable filter layer materials may include: polymeric non-shedding filter paper or laminated filter material, porous membrane of polypropylene, nylon, a composite of polycarbonate and polyester, mixed cellulose esters, cellulose triacetate, or a porous laminate thereof. Additionally other filter materials may be used.

PTFE membrane filter materials can advantageously be used to cover the adsorbent material and act as filtration membranes. As is disclosed in U.S. Pat. No. 3,953,566 to Gore, incorporated by reference, PTFE provides a number of processing advantages, such as being formable in extremely thin dimensions while remaining coherent and pin-hole free. PTFE can be made into wide widths that can be slit or extruded to the desired width.

Such a PTFE membrane filter materials achieve a filtration efficiency of 99.97% at 0.3 microns sized particles and a permeability or face velocity of 7 feet/minute (3.56 cm/sec) at 0.5 inches (1.27 cm) of water pressure. Suitable membrane filter materials are commercially available in finished filter form from W. L. Gore and Associates, Inc. A great variety of other PTFE membranes also exist with different porosities, filtration efficiencies, moisture vapor transmission rates, durability, conformability, thickness and other features which may be selected.

Filters can be very low in particulation, outgassing, and nonvolatile residues depending upon the material constructions and filter manufacturing precautions. The components can be heated to drive off other contaminants to the temperature limitations of the materials used. PTFE is advantageous because of its high temperature resistance.

Another preferred PTFE membrane filter media to encapsulate the adsorbent layer is a layer of expanded PTFE membrane made in accordance to U.S. Pat. No. 4,902,423 issued to Bacino et al. incorporated by reference.

This filter media has several advantages. Most significantly, the filter media can be made very highly permeable, with resistances to air flow of less than 0.5 mm H₂O @ 10.5 feet per minute (3.2 meters per minute) and still retain adsorbent particulate within the filter. The particle filtration efficiency of this highly expanded membrane is also very good (e.g. in excess of 55% at 0.3 μm) which provides good particle filtration along with the adsorbent retainment.

An additional value of using such a membrane is that it can be made extremely thin, possibly less than 0.001″ (0.025 mm). This can be of significant importance when filters are desired in very small devices.

This filter media may be structurally supported by a layer of woven, nonwoven, or expanded porous material, such as polyester, polypropylene, polyethylene, polyamide, etc. If used, a preferred support layer is a Reemay 2014 polyester nonwoven, 1.0 oz/yd² available from Reemay, Inc., Old Hickory, Tenn. Use of such a membrane or laminate can add particle filtration functionality to the adsorbent functionality of the filters.

Another preferred filter media to cover or encapsulate the adsorbent layer, and more preferably to be used in the embodiments with a recirculation filter, is a layer of an electrostatic triboelectret material available in finished filter form from W. L. Gore and Associates, Inc. under the trademark GORE-TRET® recirculation filters. Advantages of this media are that it can be very efficient (e.g., in excess of 90% @ 0.3 micron) and also very permeable (e.g., less than 1 mm H₂O at 10.5 fpm or 3.2 m/min). This media may temporarily lose its charge when washed with deionized water; however, it regains its charge upon drying due to the triboelectric effect of a mix of dissimilarly charged fibers.

Other filter materials can also be used. For example, other electrets or other triboelectret materials that have high efficiency and low resistances to airflow. Other filter papers or filter membranes such as polypropylene membranes or cast polymeric membranes or some combination of filter materials may also be used.

An outer protective layer can also be added to improve durability to the filter and to contain any protruding fibers from either the triboelectret type filter media or the filter support media for the membrane filter media. Such protective layers may comprise extruded or expanded plastic material such as polypropylene, polyethylene, polyamide, polyester, etc. Alternative outer layers such as point bonded nonwovens, spun bonded nonwovens, or other nonwovens may be used as outer protective or fiber containing layers.

The sorbent core 12 containing the adsorbent may comprise any number of forms, including loosely packed particles, to filled or highly filled porous materials or tablets. As the terms ‘sorbent’ and ‘sorbing’ are used herein, they are intended to encompass any material that removes contaminants from surrounding air, whether through a process of absorbing, adsorbing, or otherwise. A sorbent core formed of loosely packed particles preferably contains a binder, which holds the particles together. Suitable binders include but are not limited to fluorinated ethylene propylene (FEP), polyvinylidene fluoride (PVDF), PVP (polyvinylpyrolidone), hydroxyproplycelulose, acrylics and other commonly used binders well known in the art.

Alternatively, the sorbent core may comprise one or more layers of the adsorbent or adsorbent filled material such as a scaffold of porous polymeric material in which void spaces are filled with a sorbent. Other possible sorbent core constructions include sorbent impregnated wovens or non-wovens, such as cellulose or polymeric non-woven that may include latex or other binders, as well as porous castings of the sorbents and fillers that are polymeric or ceramic. The sorbent core may also be made up of carbonized fibers or carbonized woven fibers such as novaloid woven activated products from suppliers such as Kynol America, Inc. Additionally they may be carbonized felts or other materials that can be made into an activated adsorbent form. The sorbent core may include a single particle adsorbent or may include a mixture of different types of adsorbents. The core could also contain a layer or layers of the adsorbent beads or particles on a scrim or it could be a tablet of the adsorbent materials and binders. Such adsorbent laden or embedded fabrics and materials can easily be made to adsorbent densities in excess of 0.15 g adsorbent/cc of adsorbent material.

A preferred embodiment of the sorbent core 12 utilizes a sorbent filled PTFE sheet wherein the sorbent particles are entrapped within the PTFE structure as taught by U.S. Pat. No. 4,985,296 issued to Mortimer, Jr., incorporated herein by reference. Ideally, particles are packed in a multi-modal (e.g., bimodal or tri-modal) manner, with particles of different sizes interspersed around one another to fill as much of the available void space between particles as is possible so as to maximize the amount of active material contained in the core. This technique also allows a number of sorbents, and possibly sorbents other than carbon, to be filled into a single layer. Adsorbent containing layers can easily be made to have adsorbent loading densities in excess of 0.45 g/cc adsorbent density.

Using PTFE as a binder material for the core imparts a number of additional advantages. PTFE is a non-linting, non-outgassing inert binder that effectively reduces dusting of sorbent material during manufacturing and during the life of the filter. Additionally, processing advantages of this material include the ability to make a relatively thin, highly loaded material, per U.S. Pat. No. 4,985,296, that can be produced in a wide sheet and then cut into desired final widths. In this manner, thin adsorbent cores can be produced for very thin, low profile adsorbent filters.

The adsorbent core may also be shaped to contain grooves, bumps, or other features or may include a permeable layer adjacent to the bottom, top, or a side. Such grooves or permeable layers may aid in faster adsorption rates by allowing air and contaminants to more easily diffuse through the grooves or layers to reach the adsorbent core layer. These features can also aid lower resistance to airflow in parts designed to allow filtered airflow into the drive as in an Adsorbent Breather Filter.

The PTFE/adsorbent composite can be made in thicknesses from less than 0.001″ to 0.400″ or more. This allows a great deal of flexibility in finished filter thicknesses and adsorbent loading. Additionally, adsorbent densities approximating 80-95% of full density are possible with multi-modal packing and physical compression, so that maximum adsorbent material can be packed per unit volume. Unlike other binders such as acrylics, melted plastic resins, etc., PTFE does not block the adsorbent pores or reduce adsorption performance.

Chemisorbents (e.g., potassium permanganate, potassium carbonate, sodium carbonate, calcium carbonate, calcium sulfate, or other salts or reactants for scavenging gas phase contaminants depending on the known contaminants desired to be removed); powdered metals; ion exchange materials; catalytic fillers; as well as mixtures of some of these materials may be added to the improved adsorbent of the present invention to add additional adsorption performances in acid gasses or other unwanted vapors. For some applications it may be desirable to employ multiple layers of the adsorbent materials, with each layer containing a different adsorbent or adsorbent blend to selectively remove different contaminants as they pass through the filter.

In each embodiment of the filters utilizing the present invention, the adsorbent filter may be constructed in virtually any desired dimensions. Even for use within Disk Drives the sizes will vary significantly with the form factor of the drive and the space available to place such a filter. Filters for 3.5″ Disk Drives are typically larger because they not only have more space available, but they need to control a larger enclosed environment, while smaller drives will often require smaller parts. The adsorbent articles described herein are capable of being used in any size drive or any size enclosure.

Filters utilizing functionalized carbon can be placed in a variety of locations within the disk drive. Suggested locations within the disk drive where the filters utilizing the improved adsorbent may be mounted include near, under, or over the magnetic storage disk, near the ramp load for the read/write head, or near the armature as long as it is out of the way mechanically for operation. Filters can also be placed in small areas within slots or other features used to contain the filter.

The filters may be attached to a Disk Drive by an adhesive layer 13. The adhesive layer 13 must have a high enough peel strength to withstand the intended application and, in certain applications meet temperature and solvent resistance, FDA approval requirements and low outgassing requirements. A typical low outgassing specification is the ASTM E-595-84 specification of less than 1% total mass loss and 0.1% collected volatile condensable material. Thus, in one aspect, the invention utilizes one layer of 0.0015″ (0.0037 cm) thick permanent acrylic pressure sensitive adhesive applied to a first side of a 0.002″ (0.0050 cm) thick polymeric film and a second layer of permanent acrylic pressure sensitive adhesive 0.0015″ (0.0037 cm) thick applied on the second side of the film. The latter adhesive contacts the filter material and adsorbent; the first adhesive is used to join halves or layers of the filter assembly or to attach it to an enclosure.

An alternative embodiment may use only a single layer of transfer adhesive. In this embodiment, the adhesive functions both as the substrate for mounting the adsorbent and as the adhesive for attaching the filter to the enclosure. These adhesives should typically have medium to high peel strengths in excess of 20 ounces/inch as measured by PSTC #1 (FTMI). Suitable adhesives are commercially available from a number of sources.

The filter depicted in FIG. 2 is an adsorbent breather filter. It has a hole 15 through the adhesive layer 13 that is placed over a hole 16 in the drive case 14 such that air can flow through the filter into and out of the drive to help equilibrate differential pressures that can be created in the drive due to thermal gradients or the mechanical operation of the drive and its spinning recording disks. Optionally a diffusion tube may be incorporated into the adsorbent breather filter by providing a channel within the adhesive layers.

FIGS. 3A and 3B respectively illustrate adsorbent boxes and adsorbent breather boxes that can utilize the functionalized adsorbent of the present invention. The housing 22 of the box 20 can be any moldable or assembled material. A typical material for the housing is a moldable polycarbonate although some carbon-filled materials may also be used. A cover filter 21 is sealed to the box to contain the adsorbent material 23. The cover filter can be a membrane or membrane laminate consisting of a membrane laminated or attached to another material layer such as but not limited to a nonwoven, woven, or scrim type material. Membrane laminates of such constructions are available from W. L Gore and Associates as filtration media for laboratory filtration applications. The functionalized adsorbent can be in many forms inside the box. In one aspect, it is a box filled with the adsorbent in a powder or particulate form. In another aspect the adsorbent is adhered to or filled into a matrix material. In yet another aspect, the adsorbent is blended with a binder and made into an adsorbent in the form of a tablet. Tableting can increase the adsorbent density per unit volume and often adsorbent densities of 0.7 g/cc of tablet can be obtained. But final tablet density also is dependent upon the density of the base adsorbent so some tablet densities may be no more than 0.5 gm/cc of tablet. FIG. 3B adds a hole 24 into the box 20 such that the projection incorporating hole 24 which may be aligned with a hole in the drive wall to allow airflow between the inside of the drive and the outside of the drive for pressure equilibration.

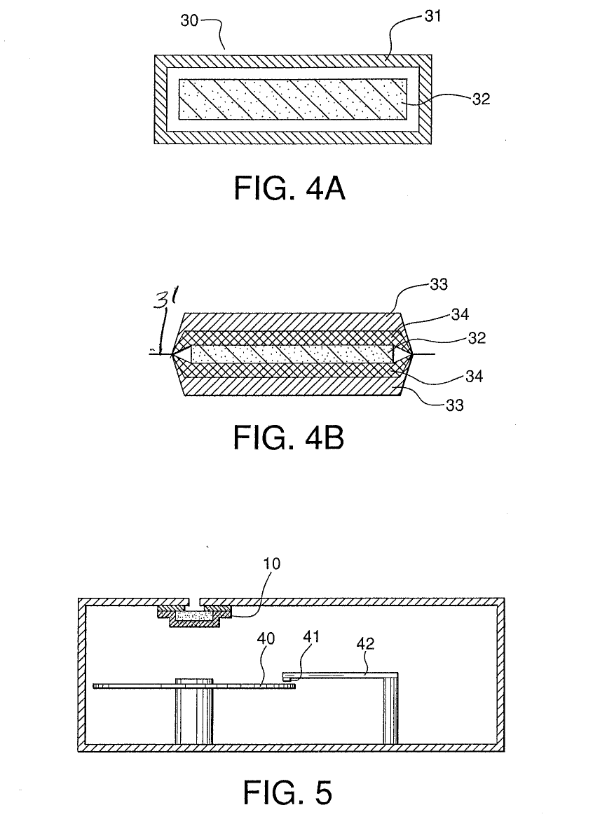

FIGS. 4A and 4B show top and cross-sectional views respectively of another filter form of an adsorbent recirculation filter 30. The adsorbent layer 32 containing the functionalized adsorbent could be a filled material or a material to which the adsorbent is adhered to as described previously. Typically a sealed border 31 will seal the filter layers together. Filter layers are shown in FIG. 4B with outer scrim layer or layers 33, filter layer or layers 34 and the adsorbent containing layer or layers 32. The filter layer or layers 34 can be any filter material or set of materials. A preferred filter material is an electret filter material. Outer scrim layer or layers 33 are typically used to contain fibers from the filter material, help contain adsorbent from the adsorbent layer and help weld and maintain the filter shape and configuration. Typical outer layers can be a polyester spunbond point bond material available from any number of known suppliers of nonwoven materials. Other materials could be extruded materials from any number of plastic materials such as but not limited to polyester, polypropylene, or polyethylene.

FIG. 5 shows a cross sectional view of a sketch of a hard disk drive with a filter 10 utilizing an embodiment of the present invention similar to that shown in FIG. 2. Also shown are the storage disk 40, recording head 41, and armature 42 that holds and positions the recording head over the rotating storage media.

### Test Procedures

Two standard criteria are commonly used to evaluate the performance of adsorbents in a Disk Drive. One criteria is a moisture isotherm and the other is capacity for low concentration organic vapor such as Trimethyl Pentane (“TMP”) at constant conditions such as 0% RH and 30 C. Procedures for developing a moisture isotherm and determining capacity for low concentration organics are described below. Additionally several methods for quantifying function end groups in activated carbons are described. Methods for determining elemental content in materials such as activated carbons are also summarized.

### Gravimetric Water Vapor Adsorption/Desorption Analysis

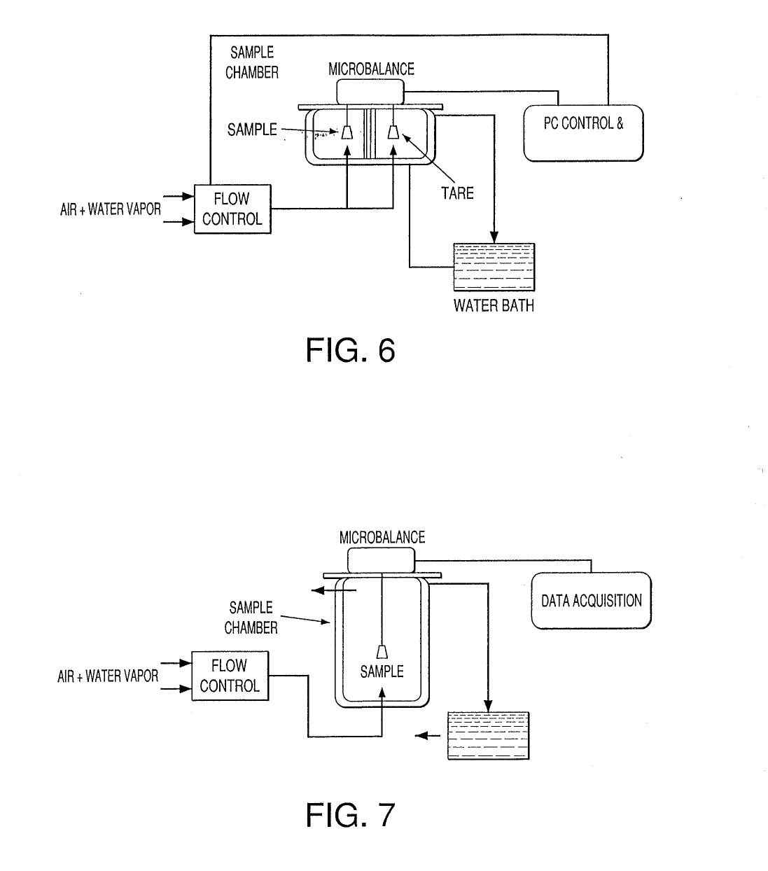

The moisture isotherm was developed using a microbalance-based water vapor adsorption desorption analyzer (VTI Corporation, Orlando, Fla.). The analyzer measures the relationship between water sorption capacities and the relative humidity (RH) levels at constant temperature and generates the moisture adsorption/desorption isotherms. The adsorbent sample is exposed to various RH levels at constant temperature, and the sample's weight change due to water vapor sorption/desorption is monitored and recorded with a high precision microbalance. As schematically illustrated in FIG. 6, the analyzer consisted of five parts: A Flow control device: controlled the flow of water vapor and carrier gas (air or nitrogen) so that a desired water vapor concentration (RH) was delivered to the sample chamber at a desired total flow rate; A brass sample chamber with water jacket and internal heater provided a constant water vapor concentration and constant temperature environment for the adsorbent sample; A Microbalance was used to measure the weight change of the adsorbent sample during the adsorption/desorption process; A Water bath was used to provide constant temperature water to flow through the sample chamber; A PC and software were used to control air flow, RH, and record microbalance data.

A sample was manually loaded into the sample holder and delivered to the sample chamber. The sample was heated to 105° C. with dry air to dry out moisture, then cooled to 25° C. Air flow with preset RH level was introduced to the sample chamber to begin the adsorption/desorption steps. At each step, the sample weight was monitored and recorded. The equilibrium sample weight, together with RH level was recorded and used to calculate the water vapor adsorption/desorption isotherm.

As used herein, the moisture capacity at moderate RH is the moisture capacity of the adsorbent between 25% and 45% RH and is expressed as a weight percentage of the adsorbent sample. The moisture capacity at moderate RH is calculated as the weight percentage of water adsorbed at 45% RH and 25 C minus the weight percentage of water adsorbed at 25% RH and 25 C.

### Gravimetric Organic Vapor Adsorption Measurement System

The capacity for adsorbing low concentration organic vapors is determined using a system schematically illustrated in FIG. 7. The system consisted of five parts: 1) Flow control, 2) Sample chamber, 3) Microbalance, 4) Water bath, and 5) Data acquisition. The adsorption ‘uptake’ curve of an adsorbent under static conditions, i.e., adsorption under constant gas/vapor concentration without significant gas flow was measured in the following manner. The organic vapor used in the procedure was 25 wppm Trimethyl Pentane (TMP) at 30° C. and 0% RH.

The flow of a test gas, consisting of TMP vapor and carrier gas (air or nitrogen) was delivered to the sample chamber at a desired total flow rate so that a desired vapor concentration can be delivered. The water-jacketed sample chamber provides a constant temperature, and flow controls provide a constant vapor concentration within the chamber. The water bath provided constant temperature water to flow through the chamber jacket. The flow rate was controlled such that, the linear flow velocity passing through the chamber was very small (less than 1.0 mm/second), to simulate the static condition, A microbalance was used to monitor the weight changes of the adsorbent sample during adsorption process. A PC and software were used to record the microbalance data.

The sample was loaded into the sample holder and placed into the sample chamber. The sample chamber was flushed with dry carrier gas until the sample weight reached equilibrium and the sample was dry. After zeroing the balance, the test gas flow was commenced and data acquisition started automatically. When the sample weight reached equilibrium, the test was complete.

As used herein, TMP capacity is the amount of TMP adsorbed onto a carbon sample expressed as a weight percentage of the carbon sample when the carbon is exposed to 25 wppm TMP at 30° C. and 0% RH

### Boehm Titration Method

Boehm titration was used to quantify functional groups on an activated carbon surface and estimate the acidic and basic properties of activated carbon. The method is based on acid/base titration of carbon acidic and basic centers.

Activated carbon needed for analysis is placed in clean, dry vials for conducting the experiment, 0.05 Normal solutions each of sodium hydroxide (NaOH), sodium carbonate (Na2CO3), sodium bicarbonate (NaHNO3), and hydrochloric acid (HCl) are also prepared. Deionized water is also used in the sample preparation. 0.05 Normal NaOH and 0.02 Normal H2SO4 are then further used for the titration.
1) The samples of activated carbon to be analyzed are thoroughly washed several times until the wash water is free of water soluble species easily removed from the activated carbon. Time is allowed for all extraneous water soluble salts, binders, etc., to be extracted from the carbon sample. This eliminates errors due to possible salt treatments added on carbons that are often used to improve acid gas adsorption.
2) Residual water left on the carbon should then be free of residual salts. Therefore the carbon sample was dried at 0% RH to remove all moisture from the activated carbon. Carbon weight without moisture is then measured.
3) One gram of the carbon to be analyzed was then placed in each of four 50 ml vials. Into the first vial was added 50 ml of the 0.05 Normal solution of Sodium Hydroxide. Into the second vial was added 50 ml of the 0.05 Normal solution of Sodium Carbonate. Into the third vial was added 50 ml of the 0.05 Normal solution of Sodium Bicarbonate. And into the fourth vial was added 50 ml of the 0.05 Normal solution of Hydrochloric Acid.
4) The four vials were then individually sealed and agitated for 24 hours at room temperature.
5) Samples from each of the first three vials were filtered through 0.2 micron AUTOVIAL's from Whatman. In turn 5 ml from each of the filtered solutions (sodium hydroxide, sodium carbonate, and sodium bicarbonate) were pipetted into separate individual clean vials. Excess base was neutralized with 0.02 Normal Sulfuric Acid solution using a pH meter to determine the pH of 4.5 end point. (One such meter is Accumet XL50 supplied by Fischer Scientific). The amount of acid needed for this titration was measured using a 10 ml burette 0.05 ml divisions) as it was added.
6) A sample of the fourth vial with the Hydrochloric Acid was also filtered with a 0.2 micron AUTOVIAL from Whatman, 5 ml of the filtered sample of Hydrochloric Acid was pipetted into a clean vial and the excess acid was neutralized with 0.05 Normal solution of Sodium Hydroxide, again using a pH meter to determine the pH endpoint of 8.2. The amount of base added for the titration was measured using a 10 ml burette (0.05 ml divisions) as it was added.
7) A blank titration of the deionized water was also done to correct for any background error.
8) The number of acidic sites was calculated as follows:
   a. The initial meq/bottle was calculated by multiplying the Normality times the weight of the solution added in step 3.
   b. The meq/g was calculated by subtracting the amount of solution added in the titration of the blank in Step 7 from the amount of solution added during the titration of the sample in Step 5 and dividing that amount by the amount of the aliquot and multiplying that result by the normality of the solution added during the titration in Step 5.
   c. The final meq/bottle was then calculated as the product of the meq/g calculated above in step b) multiplied by the weight of the solution added in step 3.
   d. The meq/100 g of sample is then calculated by subtracting the final meq/bottle calculated above in step c) from the initial meq/bottle calculated above in step a) and dividing that by the weight of the sample used in Step 3 and then multiplying that result by 100.
   e. This is done for all three vials used in step 5.
9) The number of basic sites were calculated in a similar manor for the vial used in step 6
10) Results of the test are recorded as meq/100 g (or milliequivalents/100 grams) of activated carbon sample. Meq is an abbreviation for the milligram equivalent weight or the equivalent weight in milligrams, which is recommended as an international unit.

### Elemental Analysis Methods

Elemental analysis may be used to quantify functional end groups and express them as a percentage of carbon weight. As used herein weight percentage of a sample means the weight of the non-carbon functional element divided by the total weight of the sample multiplied by 100. The weight of support carriers, binders, salts, and other non-covalently bound additives are not considered.

Elemental analysis was conducted using Galbraith Laboratory Procedure ME-11 Revision Number 15. An LECO CHN 2000 analyzer from LECO Corporation in St. Joseph Mich. was used. The analyzer combusts the sample (typically around 200 mg) in oxygen at 1000 C converting the elemental carbon, hydrogen, and nitrogen into CO₂, H₂O, N₂, and NOx respectively. These gasses are passed through infrared cells that determine the carbon and nitrogen content, and a thermal conductivity cell that determines N2. The ranges based on 200 mg sample size are between 0.01% to 100% for carbon, between 0.01% and 50% for hydrogen, and between 0.01% and 50% for nitrogen. Tin powder or vanadium pentoxide (V₂O₅) can be added for difficult-to combust samples. Appropriate calibration samples and blanks are run before and with the samples to verify accuracy as described in the owners manual and instructions. A calibration sample should be NIST-traceable such as NIST-traceable acetanilide (NIST SRM 141C) which is 71.09% carbon, 6.71% hydrogen, and 10.36% nitrogen. Control or reference samples should also be run appropriately such as the above mentioned acetanilide or other materials such as ethylenediaminetetraacetic (EDTA).

Oxygen was analyzed using Galbraith Laboratories Method E8-3 rev 8 using a PerkinElmer 240 Elemental Analyzer (Oxygen Modification). The sample (1.0 to 2.5 mg) was pyrolized in a stream of helium at 1000 C over platinized carbon; producing CO which is converted to CO₂ by Copper II oxide (cupric oxide). Determination was made by thermal conductivity detector and a microprocessor calculated the sample O₂ content as weight percent based on manual weight entry. Acetanilide was used as a calibration standard and control reference to verify data accuracy. Also if certain chemicals are present in sufficient quantities, an alternative method would be needed to get accurate results. References for this method are the instruction manual for the Model 240 Elemental analyzer from PerkinElmer Corporation in Wellesley Mass., as well as Handbook of Practical Organic Micro-Analysis: Recommended Methods for Determining Elements and Groups by S. Bance published in 1980.

Fluorine, Bromine and Chlorine and other elements may be analyzed by these and other known methods. For example, Flourine may be measured using ASTM 1179, Test Method BD 3761 Mod ISE, Galbraith Method E35-2 may be used to determine Bromine functional end groups, and Flourine may be determined by using Galbraith Method E9-1.

### EXAMPLES

Without intending to limit the scope of the present invention, the following examples illustrate how the present invention may be made and used:

### Example 1

A part number 3042 activated carbon was obtained from Calgon Carbon Corporation. 100 g of the carbon was further treated to effect oxygen containing functional end groups onto the carbon surface by soaking the activated carbon for two hours with a 560 g ammonia persulfate and 100 ml sulfuric acid in solution with 1000 ml of water, after which the carbon was rinsed of residual solution numerous times and dried. Washing or rinsing with Dl water should be continued until the residual reagents have been removed from the carbon. Testing with elemental analysis and Boehm titration resulted in 17.6% oxygen by weight and 175.3 meq/100 gm total acidic groups. The gravimetric water adsorption and gravimetric organic vapor adsorption tests were also performed and resulted in a moisture capacity from 25% RH to 45% RH of 17.2% by weight and a TMP capacity of 20.9% by weight. This performance compares favorably to adsorbents previously used in Disk Drives. Table 1 compares the performance of Example 1 to several comparative adsorbents found in available Disk Drives.

TABLE 1

| | TMP | H₂O capacity | H₂O capacity |
|---|---|---|---|
| | capacity | 25%–45% RH | 25%–45% RH |
| Sample | (Wt %) | (Wt %) | (g/cc) |
| Inventive Example 1 | 20.9 | 17.2 | 0.0946 |
| Comparative Example 1 | 26.7 | 6 | 0.0112 |
| Comparative Example 2 | 4.5 | 7.9 | 0.0079 |
| Comparative Example 3 | 22.8 | 6.5 | 0.026 |
| Comparative Example 4 | 20.9 | 9.5 | 0.0428 |

### Example 2

An adsorbent felt VAF100 was purchased from Shanghai No. 1 Activated Carbon Fiber Co., Ltd. in Shanghai 200436, China. Elemental analysis and Boehm titration resulted in 11.39% oxygen by weight and 77.4 meq/100 gm total acidic groups.

The adsorbent was tested according to the described gravimetric water vapor adsorption and gravimetric organic vapor adsorption tests and resulted in a moisture capacity from 25% RH to 45% RH of 22.2% by weight and a TMP capacity of 23.8% by weight.

Table 2 reflects the moisture capacity at moderate RH of the examples and that of adsorber devices removed from commercially available Disk Drives. Table 2 also shows the increased oxygen content and acidity of the Examples when compared to known adsorber devices.

TABLE 2

| | | | Boehm | Boehm | Boehm |
|---|---|---|---|---|---|
| | H₂O capacity | Oxygen | Titration | Titration | Titration |
| | 25%–45% RH | Content | NaHCO₃ | Na₂CO₃ | NaOH |
| Sample | (Wt. %) | (Wt. %) | (meq/100 g) | (meq/100 g) | (meq/100 g) |
| Inventive Example 1 | 17.2 | 16.9 | 87.3 | 112.2 | 175.3 |
| Inventive Example 2 | 22.2 | 11.39 | 22 | 44.3 | 77.4 |
| Comparative Example 5 | 0.5 | 1.74 | −1.9 | 2.0 | 7.7 |
| Competitive Sample 6 | 12.3 | 12.46 | 5.1 | 12.2 | 27.3 |
| Competitive Sample 7 | 8.2 | 6.67 | 2.3 | 12.5 | 23.5 |

### Example 3

An adsorbent assembly was made having the following features: A polyester film having a thickness of 0.003 inches was coated with an adhesive on two sides. The adhesive was 0.0015 inch thick high temperature acrylic pressure sensitive adhesive. This double sided adhesive construction is available from Adhesives Research Company in Glenn Rock Pa.

An 80 wt % activated carbon and 20 wt % PTFE adsorbent core was made. The material mix was co-coagulated following procedures described in U.S. Pat. No. 4,985,296. The material was then dough-balled and rolled into thick sheets about 350 mils thick, 5 inches long and 3 inches wide with a metal rolling pin. The sheets were heated to 60° C. then were cross-calendared into tapes in eight successive passes. The speed through all roll-downs was about 1.52 meters per minute. The first two passes were first in the x direction and then the y direction using a gap setting of 150 mils. The third and fourth passes were again in the x direction and then the y direction with a gap setting of 100 mils. The next two passes again in the x and then y directions used a gap setting of 50 mils and the final two passes again in the x and then y directions used a gap setting of 20 mils. The resulting tape was about 90 mils thick and was compressible with some memory. The edges of the tape were trimmed to 5 inches by 6 inches and placed in a 180° C. oven for twenty minutes, flipping the sheets over after ten minutes.

The adsorbent tape had a final density of 0.453 g/cc or a carbon density of 0.362 g/cc. Using the adsorbent performance data of the raw carbon data of Example 2, the adsorption performance of the filled tape can be calculated:

Predicted moisture capacity at moderate RH is 0.0955 g/cc at 95% RH is 0.2365 g/cc. The calculated TMP capacity is 0.1023 g/cc.

Table 3 shows the calculated moisture and TMP performance of the carbon on a per volume basis of the filled tape in Example 3 and that measured in known devices for disc drives.

TABLE 3

| | TMP | H₂O Capacity | H₂O at |
|---|---|---|---|
| | Capacity | 25%–45% RH | 95% RH |
| | (g/cc) | (g/cc) | (g/cc) |
| Example 3 | 0.0804 | 0.0862 | 0.1991 |
| Comparative Example 17 | 0.0941 | 0.0428 | 0.2025 |
| Comparative Example 18 | N/A | 0.0661 | 0.2246 |

### Example 4

An adsorbent tablet was made using ground carbon from Example 2 and a 20% hydroxylpropyl cellulose binder and a hand tablet press compressing the mixture into a compressed rectangular tablet with dimensions of 0.312″ by 0.25″ by 0.060″. Elemental analysis and Boehm titration resulted in 11.3% oxygen by carbon weight and 77 meq/100 gm of carbon total acidic groups. The adsorbent tablet was tested according to the described gravimetric water adsorption test and resulted in a moisture capacity from 25% RH to 45% RH of 22.2% by carbon weight.

### Examples 5 Through 16

Several examples of functionalized carbon were prepared, each having a different combination of treatment time, temperature and ammonium persulfate concentration. 50 g of the RMS raw carbon from Example 1 was treated with different amounts of ammonium persulfate in water for various time temperature conditions and the adsorption capacity difference between 45% RH and 25% RH was determined by gravimetric difference between dried samples placed in first a 25% RH chamber at 25 C and then a 45% RH chamber at 25 C allowing equilibrium conditions in each chamber before weighing. Oxygen content was also measured.

The ammonium persulfate was added to deionized water in a temperature controlled 1 liter reaction kettle. While stirring the solution, the carbon was slowly added. Temperature recorded periodically to monitor the temperature rise due to the exothermic reaction. Following the reaction time for each sample (listed below) the sample was initially filtered through a Buchner funnel flushing with about 600 ml of deionized water. The filtered carbon was then transferred to a beaker. About 400 ml of deionized water was added to the beaker and stirred for 15 minutes with a magnetic stirrer before the beaker was removed from the stir plate and the carbon allowed to settle. Once the carbon settled, the standing liquid was decanted off. This rinsing process was repeated two more times for a total of three rinses and then another 400 ml of water was added to the beaker and left to soak for at least 24 hours. After the 24 hours, the standing liquid was decanted off and the carbon rinsed one more time similar to the above rinsing procedure. Then the material was again filtered through a Buchner funnel with about 600 ml of deionized water. The carbon was then dried at 100 C in a convection oven for at least 24 hours. Table 4 relates the time, temperature, concentration, moisture adsorption gravimetric deltas, and oxygen content found for these samples.

TABLE 4

| | | | | | Moisture | | | | |
|---|---|---|---|---|---|---|---|---|---|
| | | | | | Capacity at | | | | Boehm |
| | | | | | 25% RH–45% | Oxygen | Nitrogen | Hydrogen | Titration |
| | Time | Temp | APS | Water | RH | Content | Content | Content | NaOH |
| | (hrs) | (° C.) | (g) | (g) | (Δ wt %) | (Wt %) | (Wt %) | (Wt %) | (meq/100 g) |
| Example 5 | 0.25 | 25 | 50 | 450 | 18.03 | 14.80 | <0.5 | 2.79 | 87.51 |
| Example 6 | 0.5 | 25 | 50 | 450 | 18.72 | 13.28 | <0.5 | 2.90 | N/A |
| Example 7 | 0.75 | 25 | 50 | 450 | 17.28 | 13.19 | <0.5 | 2.66 | N/A |
| Example 8 | 1 | 25 | 50 | 450 | 16.82 | 14.30 | <0.5 | 3.08 | N/A |
| Example 9 | 2 | 25 | 50 | 450 | 17.30 | 18.08 | <0.5 | 2.79 | 96.45 |
| Example 10 | 1 | 25 | 25 | 475 | 18.95 | 20.23 | <0.5 | 2.92 | N/A |
| Example 11 | 2 | 25 | 25 | 475 | 18.58 | 18.28 | <0.5 | 2.90 | N/A |
| Example 12 | 1 | 25 | 10 | 490 | 18.29 | 17.86 | <0.5 | 3.00 | N/A |
| Example 13 | 2 | 25 | 10 | 490 | 18.44 | 10.78 | <0.5 | 2.64 | 57.87 |
| Example 14 | 3 | 25 | 10 | 490 | 18.20 | 13.94 | <0.5 | 3.19 | N/A |
| Example 15 | 1 | 60 | 25 | 475 | 18.54 | 11.67 | <0.5 | 3.16 | N/A |
| Example 16 | 2 | 60 | 25 | 475 | 18.62 | 10.92 | <0.5 | 2.74 | 70.14 |

### Examples 17 Through 18

In further examples, treatment parameters of time, temperature and peroxide concentration were varied. 50 grams of the RMS raw carbon from Example 1 was treated with different amounts of peroxide in water for various time temperature conditions.

The samples were prepared using the procedures described in the previous examples. However, the reagent used in Examples 17 and 18 was peroxide. The initial peroxide solution used was a 35 wt % solution of peroxide in water. Dilutions were made mixing deionized water with the 35% by weight solution. Oxygen content was evaluated. Gravimetric analysis was used to determine adsorption capacity between 45% RH and 25%. The difference between dried samples placed in first a 25% RH chamber at 25 C and then a 45RH chamber at 25 C allowing equilibrium conditions in each chamber before weighing. Table 5 relates the time, temperature, concentration, gravimetric deltas and oxygen content levels found.

TABLE 5

| | | | | Moisture | | |
|---|---|---|---|---|---|---|
| | | | | Capacity | | |
| | | | | of | | Boehm |
| | | | Wt % | 25%–45% | Oxygen | Titration |
| | Time | Temp | H₂0₂ | RH | content | NaOH |
| | (hrs) | (° C.) | Solution | (Wt %) | (Wt %) | (meq/100 g) |
| Example 17 | 1 | 25 | 35 | 19.43 | 11.86 | 53.51 |
| Example 18 | 2 | 25 | 35 | 17.76 | 8.32 | N/A |

While particular embodiments of the present invention have been illustrated and described herein, the invention is not be limited to such illustrations and descriptions. Numerous ways may be employed to create carbon having functional end groups. By way of example, ozone, nitric acid, sodium persulfate, sulfuric acid, potassium permanganate may be used to treat activated carbon to add functional end groups. Also, carbon having functional end groups can be created by proper selection of the precursor material and activation process, which allow functional groups to form during or after activation. It should be apparent that changes and modifications may be incorporated and embodied as part of the present invention within the scope of the following claims.

We claim:

1. An adsorbent article for a disk drive comprising carbon adsorbent, said carbon adsorbent having functional end groups comprising oxygen such that the carbon adsorbent comprises at least about 13.5 percent oxygen by weight.

2. The adsorbent article of claim 1 in which said carbon adsorbent comprises at least 15.0 percent oxygen by weight.

3. The adsorbent article of claim 1 in which the functional end groups are selected from the group consisting of anhydrides, carboxyls, carbonyls, carboxylic acids, phenols, quinones, ethers and lactones.

4. The adsorbent article of claim 1 in which the functional end groups are covalently bonded to the carbon adsorbent such that the end groups impart new chemical functionality to the carbon adsorbent.

5. The adsorbent article of claim 1, in which said carbon adsorbent is in a form selected from the group of a tablet, filled tape adsorbent embedded fabric, adsorbent beads and adsorbent granules.

6. An adsorbent article for a disk drive comprising carbon adsorbent, said carbon adsorbent having functional end groups such that said carbon adsorbent comprises at least about 6.0 percent of an element selected from the group consisting of nitrogen, sulfur, phosphorous, bromine, chlorine, and fluorine.

7. The adsorbent article of claim 6, in which the functional end groups are selected from the group consisting of amines, phosphates, sulfates, chlorides, fluorides.

8. An adsorbent article for a disk drive comprising carbon adsorbent, said carbon adsorbent having more than about 40 meq/100 grams of total acidity as determined by Boehm titration.

9. The adsorbent article of claim 8 in which said carbon adsorbent has more than 50 meq/100 grams of total acidity as determined by Boehm titration.

10. The adsorbent article of claim 8 in which said carbon adsorbent has more than 70 meq/100 grams of total acidity as determined by Boehm titration.

11. The adsorbent article of claim 8 in which said carbon adsorbent has more than 90 meq/100 grams of total acidity as determined by Boehm titration.

12. An adsorbent device for a disk drive comprising carbon adsorbent, said carbon adsorbent adapted to have a moisture capacity at moderate RH of greater 14%.

13. The adsorbent device of claim 12 in which the carbon adsorbent is adapted to have a moisture capacity at moderate RH of greater than 17%.

14. The adsorbent device of claim 12 in which the carbon adsorbent is adapted to have a moisture capacity at moderate RH of greater than 20%.

15. An adsorbent device for a disc drive comprising carbon adsorbent, said carbon adsorbent adapted to absorb moisture such that the adsorbent device adsorbs at least 0.08 g water per cubic centimeter of adsorbent device volume at moderate RH.

16. The adsorbent device of claim 15 in which said carbon adsorbent is adapted to adsorb at least 0.10 g water per cubic centimeter of adsorbent device volume at moderate RH.

17. An adsorbent device for a disk drive comprising carbon adsorbent adapted such that the adsorbent has a moisture capacity of at least 14% at moderate RH and a TMP capacity of at least about 17.5 percent by weight.
